(19) United States
(12) Patent Application Publication
(10) Pub. No.: US 2009/0290181 A1
(43) Pub. Date: Nov. 26, 2009

(54) IMAGE RECORDING APPARATUS AND CONTROL METHOD FOR SAME

(75) Inventor: Naoki ISHII, Tokyo (JP)

Correspondence Address: FRISHAUF, HOLTZ, GOODMAN & CHICK, P.C., 220 Fifth Avenue - 16th Floor, New York, NY, 10017-2023, US

(73) Assignee: Olympus Corporation, Tokyo (JP)

(21) Appl. No.: 12/466,558

(22) Filed: May 15, 2009

(30) Foreign Application Priority Data
May 20, 2008 (JP) 2008-131542

(51) Int. Cl. H04N 1/60

(52) U.S. Cl. 358/1.9

(57) ABSTRACT

An image recording apparatus having a plurality of stack units used for stacking recording media, comprising: a transport path changeover unit which transports the recording media to the plurality of stack units; an inversion unit which transports the recording medium by inverting it; and a recording face uniformity control unit which changes over the order between the front face and back face of a printed face on the basis of print job information from a host apparatus, wherein the recording face uniformity control unit changes over the order of the printed faces and also gives the inversion unit and transport path changeover unit respective instructions to invert the recording medium and to change over the transport path for the recording medium, thereby stacking the recording media in the plurality of stack units with the orientation of the recorded face of the recording media uniform in each respective stack unit.

### CROSS REFERENCE TO RELATED APPLICATIONS

This application claims the benefit of Japan Patent Application No. 2008-131542 filed May 20, 2008, the contents of which are incorporated by this reference.

### BACKGROUND OF THE INVENTION

1. Field of the Invention

The present invention relates to an image recording apparatus comprising a plurality of stack units for stacking post-recording process recording media, and specifically to a technique used for suppressing a reduction in the efficiency of the recording process when the stack units are full.

2. Description of the Related Art

Known image recording apparatuses recording an image on a recording medium, such as paper, include printers, fax machines and copiers.

In such an image recording apparatus, occurrences of the recording process stalling due to a paper exit unit stacking the post-recording process recording media increase with increases is in the chances of performing a large number of recording processes associated with the speeding up of the recording process.

A configuration equipped with a plurality of paper exit units for stacking post-recording process recording media is a known technique for solving the above described problem.

For example, reference patent document 1 (i.e., Laid-Open Japanese Patent Application Publication No. 2001-247249) has disclosed an image forming apparatus comprising a plurality of paper exit units, wherein a recording medium or media are made to exit to another paper exit unit, and are stacked therein, until a certain job is completed, if the paper exit unit selected for the job is completely filled with the recording media.

The image forming apparatus disclosed by patent document 1 comprises the paper exit units, which are changed over when a paper exit unit is detected as being filled with recording media and which have a shifter function. Further, the exiting recording media are ejected and stacked by offsetting them in order to distinguish them from the already stacked recording media.

Further, the image forming apparatus disclosed by patent document 1 is configured to output an alarm signal when a paper exit unit is filled with the recording media.

As such, the image forming apparatus disclosed by patent document 1 is configured to enable another paper exit unit to continuously stack the post-recording process recording media even when a paper exit unit stacking the recording media, which have been subjected to a large volume of recording processes, is completely filled with the media, and thereby it is possible to limit a reduction in efficiency of the recording process.

### SUMMARY OF THE INVENTION

An image recording apparatus according to one aspect of the present invention comprises: a recording unit which performs a recording on a recording medium, and a recording face uniformity control unit which changed over the order of pages on which a recording is performed on the recording medium by means of the recording unit.

A control method used for an image recording apparatus according to another aspect of the present invention is a control method used for an image recording apparatus performing a recording on a recording medium, the method comprising: determining a stacking destination for stacking the recorded recording medium or media depending both on a job giving instructions that an image be formed from a host apparatus connected to the image recording apparatus and on whether or not a stacking destination stacking the recorded recording medium or media is full; and changing over the sequences of pages on which a recording is performed on the recording medium on the basis of the information within the job and the determined stacking destination.

### BRIEF DESCRIPTION OF THE DRAWINGS

FIG. 1 is a conceptual block diagram showing an exemplary configuration of an image recording apparatus according to the present preferred embodiment;

FIG. 2 is a diagram illustrating an exemplary layout of the individual constituent components of an image recording apparatus according to the present embodiment;

FIG. 3 is a timing chart showing the relationship between a recording face uniformity processing and the timing of a recording process performed by an image recording apparatus;

FIG. 4A is a diagram showing the state of a stack unit stacking recording media prior to a recording face uniformity processing;

FIG. 4B is a diagram showing the state of a stack unit stacking recording media after a recording face uniformity processing; and

FIG. 5 is a flow chart showing the processing content of control processing related to preventing a decrease in a recording process throughput due to a storage destination being full.

### DESCRIPTION OF THE PREFERRED EMBODIMENTS

The following is a description, in detail, of the preferred embodiment of the present invention with reference to the accompanying drawings.

The following description exemplifies the case of a full line type printer employing an inkjet system.

The full line printer comprises nozzle arrays (i.e., recording heads) provided for individual colors placed apart from one another at predetermined intervals in the direction of transporting a recording medium (i.e., the secondary scanning direction). The nozzle array is equipped with a plurality of nozzles used for jetting ink in such a manner as to form the nozzles across a length that is no less than the width of the recording medium in the direction that is orthogonal to the secondary scanning direction (i.e., in the primary scanning direction). The full line printer causes a plurality of nozzles of the nozzle arrays provided for the respective colors to jet respective inks onto the recording medium, thereby making it possible to perform a high speed recording process of a desired character and/or image.

Note that the image recording apparatus according to the present embodiment may be any apparatus, such as a laser printer, a copying machine (“copier”) or the like, for which a high throughput is required, in lieu of being limited to a full line printer.

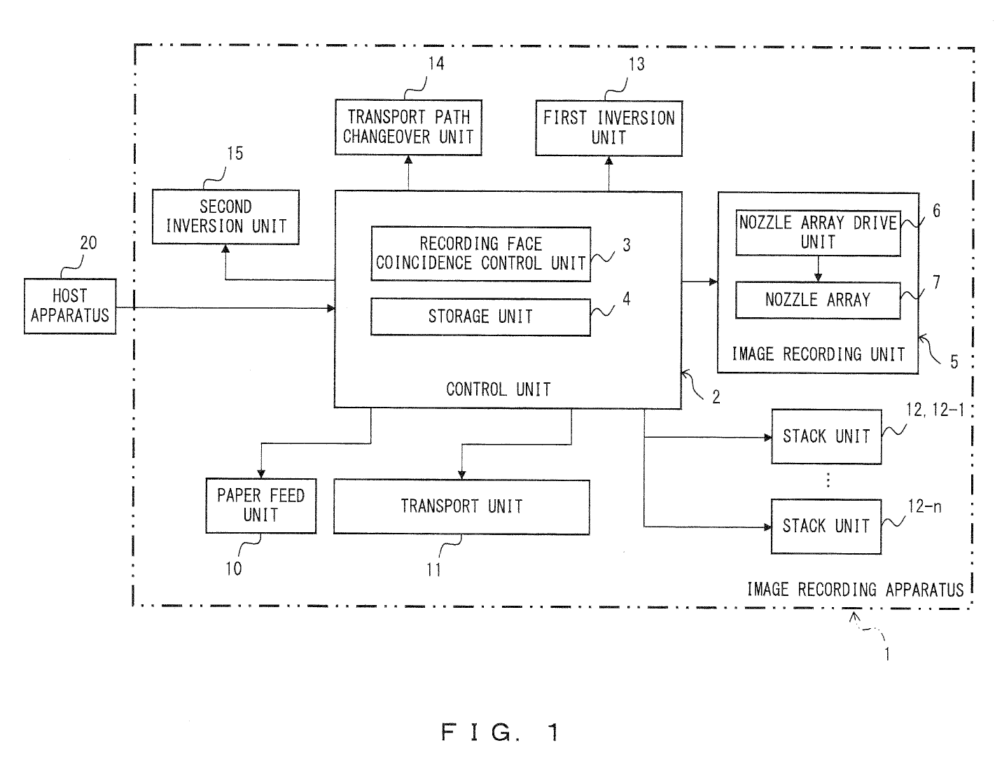

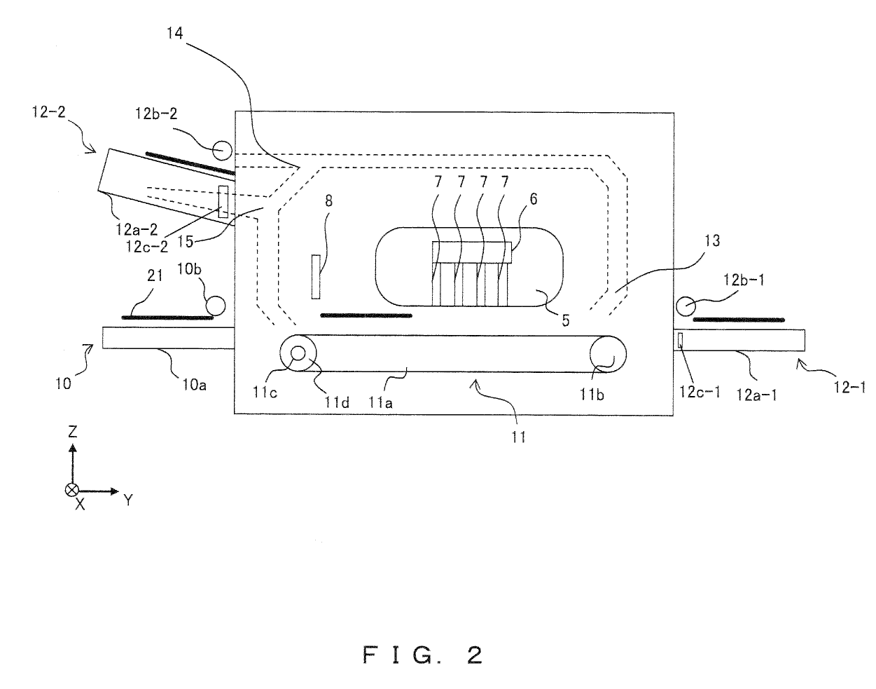

FIG. 1 is a conceptual block diagram showing an exemplary configuration of an image recording apparatus according to the present embodiment, and FIG. 2 is a diagram illustrating an exemplary layout of the individual constituent components of an image recording apparatus according to the present embodiment.

The image recording apparatus 1 shown in FIGS. 1 and 2 performs a recording process by causing an image recording unit 5, which comprises at least one nozzle array 7 equipped with a plurality of nozzles, to jet an ink onto a recording medium 21 on the basis of job information notified from a host apparatus 20. The image recording apparatus 1 comprises at least a control unit 2, an image recording unit 5, a stack unit 12, a paper feed unit 10, a transport unit 11, a first inversion unit 13, and a second inversion unit 15. Note that FIG. 2 does not depict the control unit 2.

The control unit 2 is an arithmetic operation apparatus furnished with, for example, a control function and an arithmetic operation function. The control unit 2 comprises: at least a control processing circuit constituted by a micro processor unit (MPU), read only memory (ROM) used for storing a control program, random access memory (RAM) used by the MPU as a working memory space, and other relevant devices; and nonvolatile memory used for storing various setup values related to controlling the image recording apparatus 1.

For the control unit 2 of the image recording apparatus 1, for example, a storage unit 4 is constituted by the aforementioned RAM and nonvolatile memory. Further, the control unit 2 comprises a recording face uniformity control unit 3 that results from, for example, the MPU executing the control program, and is configured to pre-store the control program in, for example, the ROM.

Note that a judgment condition used for executing a recording sequence change process is pre-stored in a predefined storage zone of the storage unit 4. The judgment condition includes the orientation information of recording media, information which is applicable when they are stacked together, for each of the plural stacking units; stackable recording medium size information; and similar information.

Note that the recording face uniformity control unit 3 may alternatively be configured as a signal processing circuit as hardware controlled by the arithmetic operation apparatus of the control unit 2.

The image recording unit 5 comprises at least one nozzle array 7 equipped with a plurality of nozzles for jetting ink in order to perform, for example, a recording process; and a nozzle array drive unit 6 used for respectively driving the plurality of nozzles of the nozzle array 7 in accordance with a drive instruction issued from the control unit 2.

The stack unit 12 comprises a plurality of stack units 12-1 through 12-n (where “n” is a positive integer) used for stacking so as to differentiate the orientation of the front and back of the recording media on which an image is formed.

For example, the stack unit 12-1 is equipped downstream of the transport unit 11, and comprises a feed roller 12b-1, a detection unit 12c-1 used for indicating that a stacking volume is full, and a stack tray 12a-1.

The stack unit 12-1 is configured to stack a recording medium 21 transported on the transport unit 11 in the stack tray 12a-1 by means of the feed roller 12b-1.

Further, the stack unit 12-2 is equipped on the downstream of the transport unit 11, and comprises a feed roller 12b-2, a detection unit 12c-2 used for indicating that a stacking volume is full, and a stack tray 12a-2. The stack unit 12-2 is configured to stack the recording medium 21 transported on the transport unit 11 in the stack tray 12a-2 by means of the feed roller 12b-2 after the recording medium 21 is inverted, front to back, in a the first inversion unit 13.

The feed unit 10 comprises: a feed tray 10a used for stacking, for example, recording media 21; and a feed roller 10b used for feeding a recording medium 21. The feed unit 10 drives the feed roller 10b in accordance with an instruction from the control unit 2, thereby feeding the recording medium 21 to a position detected by a recording medium detection unit 8.

The transport unit 11 comprises a transport member 11a, a transport drive unit 11b, a transport driven unit lid, and a transport information generation unit 11c.

Here, the transport member 11a transports, under the image recording unit 5, a recording medium 21 fed by the feed unit 10. Further, receiving a drive instruction from the control unit 2, the transport drive unit 11b drives the transport member 11a. Further, the transport information generation unit 11c generates transport distance information (i.e., moving distance information) of a transported recording medium 21. The control unit 2 determines the timing of an ink jetting from the nozzle array 7 of the image recording unit 5 on the basis of the transport distance information.

The control unit 2 starts to obtain, from the transport information generation unit 11c, the transport information of a recording medium 21 at a timing at which the present recording medium 21 reaches the position detected by the recording medium detection unit 8. Then, the control unit 2 controls the nozzle array drive unit 6 so as to cause the nozzle array 7 to jet the ink at the timing at which the recording medium 21 is transported to the position opposite to the nozzle array 7, thereby carrying out a recording process.

The control unit 2 determines the stacking destination of a recording medium 21 as either the stack unit 12-1 or stack unit 12-2 on the basis of a recording job instruction issued from the host apparatus 20.

When performing a duplex recording, the control unit 2 controls a transport changeover unit 14 so as to transport a recording medium 21 to the first inversion unit 13 after the completion of a recording process on a first face of the present recording medium 21 and to further transport it to the second inversion unit 15. Then the control unit 2 causes the second inversion unit 15 to invert, front to back, the recording medium 21 transported to the second inversion unit 15 by means of a switch-back process thereof in order to transport the recording medium 21 by way of the transport unit 11, thereby carrying out a duplex recording process.

When a duplex-recorded recording medium 21 is stacked in the stack unit 12-2, the control unit 2 performs a control in such a manner as to transport a recording medium 21 to the first inversion unit 13. The control unit 2 further changes over the transport changeover unit 14 so as to stack the recording medium 21 in the stack unit 12-2.

On the other hand, when a duplex-recorded recording mediums 21 is stacked in the stack unit 12-1, the control unit 2 performs a control in such a manner as to eject the recording medium 21 to the stack unit 12-1 from the transport unit 11 so that the present recording medium is stacked in the stack unit 12-1.

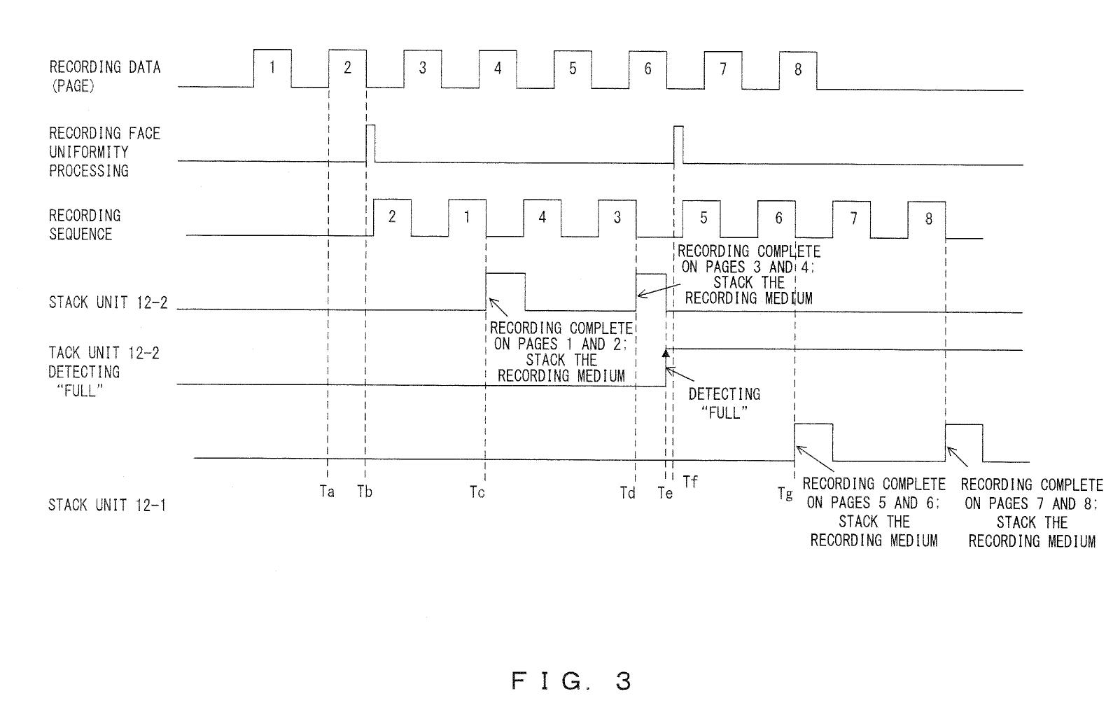

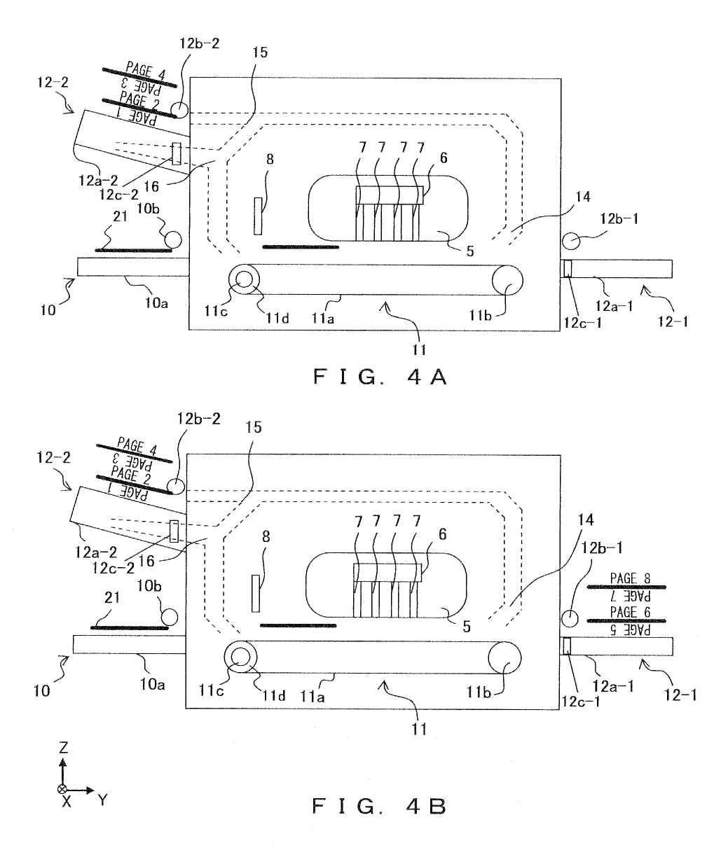

Next is a description of the execution timing of a recording face uniformity processing performed in the image recording apparatus 1, with reference to FIGS. 3 and 4. Here, the description is provided on an assumption that a host apparatus 20 has been notified of the job information so as to perform a duplex recording.

FIG. 3 is a timing chart showing the relationship between a recording face uniformity processing and the timing of a recording process performed by an image recording apparatus, and FIG. 4 is a diagram showing the orientation of recording media 21 stacked in two stack units as a result of the recording face uniformity processing.

The timing chart shown in FIG. 3 expresses the relationship among the timing of detecting a full stack in the stack unit 12-2, the timing of determining and changing recording sequences, and a page for forming an image sent from the host apparatus 20. Further, in the timing chart shown in FIG. 3, an H period indicates the period of executing an individual process of the binary logic constituted by low (L) and high (H) while an L period indicates the period of not executing the individual process of this binary logic.

The following is a description of an operation of the image recording apparatus 1 along the elapsed time indicated on the upper side of FIG. 3, and also with reference to FIG. 4.

First, at the timing Ta of FIG. 3, the control unit 2 receives the recording data for page 2 as the job information notified from the host apparatus 20.

Receiving the recording data for page 2, thus completing the reception of the image information to be recorded on the recording medium 21, the recording face uniformity control unit 3 of the control unit 2 determines a recording sequence by means of a recording face uniformity processing at the timing Tb. In this event, the recording face uniformity control unit 3 determines the stacking destination of the recording medium 21, on which the images of pages 1 and 2 will be formed, to be the stack unit 12-2 on the basis of the job information.

As shown in FIG. 4A, the stack unit 12-2 stacks the duplex-recorded recording medium 21 so that the face on which a recording is applied first is facing up. Therefore, the recording face uniformity control unit 3 determines a recording sequence by means of the recording face uniformity processing so as to record the page 2 first, followed by recording the page 1.

Then, the control unit 2 starts a recording process in a page sequence on the basis of the information determined by the recording face uniformity control unit 3.

Then, at the timing Tc, the recording medium 21 on which the recording process is completed is stacked in the stack unit 12-2 with page 1 facing down and page 2 facing up as shown in FIG. 4A.

A state of the stack unit 12-2 being full is not detected in this stacking process, and therefore the control unit 2 continues to carry out the recording process in the order of page 4 and page 3 and likewise stacks the recording medium on which the recording process is completed in the stack unit 12-2 at the timing Td.

Then at the timing Te, if the recording face uniformity control unit 3 detects the stack unit 12-2 being full, it starts the recording face uniformity processing at the timing Tf.

In the recording face uniformity processing, the recording face uniformity control unit 3 determines that it is possible to store the recording medium 21 in the stack unit 12-1 and determines that a recording medium 21 generated by the subsequent recording process is to be stacked in the stack unit 12-1.

Meanwhile, the duplex-recorded recording medium 21 is stacked in the stack unit 12-1 with the surface on which a recording process is applied first facing down as shown in FIG. 4B, and accordingly the recording face uniformity control unit 3 determines a recording sequence so as to carry out the recording process on page 5 first and then on page 6.

Then, the control unit 2 starts a recording process on the basis of the information determined by the recording face uniformity control unit 3.

Then the recording process-completed recording medium 21 is stacked in the stack unit 12-1 with page 5 facing down as shown in FIG. 4B at the timing Tg.

A state of the stack unit 12-1 being full is not detected in this stacking process and accordingly the control unit 2 continues to carry out the recording process in the order of page 7 and page 8 and likewise stacks the recording medium on which the recording process is completed in the stack unit 12-1.

As described above, recording face uniformity control unit 3 carries out the recording face uniformity processing in order to change the stacking destinations on the basis of the job information notified from the host apparatus 20.

Next is a description of a method for controlling the image recording apparatus 1 in order to prevent the throughput of a recording process from decreasing, which is caused by the stacking destination being full. This method is performed by the recording face uniformity control unit 3 of the image recording apparatus 1 according to the present embodiment.

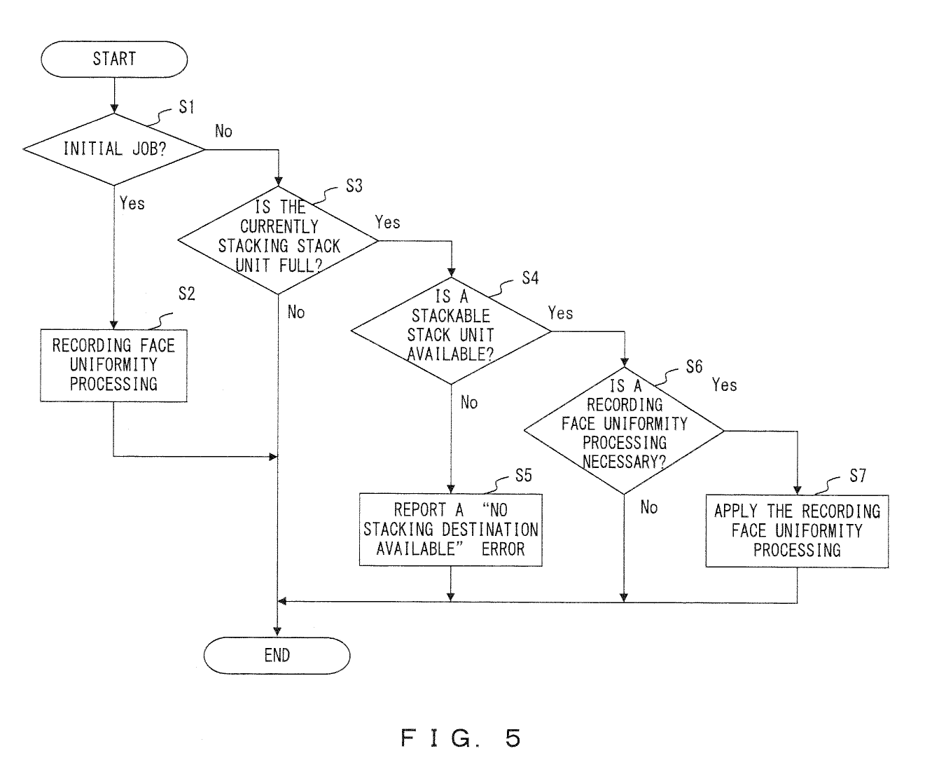

FIG. 5 is a flow chart showing the processing content of control processing, as performed by the control unit 2, related to preventing a decrease in a recording process throughput due to a storage destination being full.

The process shown in FIG. 5 is implemented by the MPU reading, and executing, a control program pre-stored in the ROM of the control unit 2. The control unit 2 functions as the recording face uniformity control unit 3 as a result of the MPU executing the control program.

The control unit 2, when starting the process of FIG. 5, in step S1 first judges whether a job received from the host apparatus 20 is an initial job or a continued job and, if it is the initial job (i.e., “yes” for S1), the process proceeds to S2. Here, the stack unit 12 is assumed to not be full in the initial job. Then in S2, a recording face uniformity processing for changing the sequence of printing pages is carried out and then the present process is finished.

In contrast, if it is not an initial job in S1 (i.e., “no” for S1), the process proceeds to S3. In S3, whether or not the currently stacking stack unit 12 is full is detected and determined. If the detection is such that the currently stacking stack unit 12 is full (i.e., “yes” for S3) in this event, the control unit shifts the process to S4. In contrast, if the present stack unit 12 is detected to be not full (i.e., “no” for S3), the control unit 2 finishes the present process.

In S4, the control unit 2 judges whether or not there is a stack unit 12 among the plurality of stack units 12-1 through 12-n that is capable of stacking, on the basis of the job information in execution. Here, if the judgment is that there is no stack unit 12 capable of staking (i.e., “no” for S4), the control unit proceeds the process to S5. In S5, the control unit 2 reports an error notifying the user of the fact that the printing cannot be continued because there is no stacking destination, and ends the present process.

In contrast, if the control unit 2 judges that there is a stack unit 12 capable of stacking in S4 (i.e., “yes” for S4), it shifts the process to S6.

In S6, the control unit 2 judges whether or not a recording face uniformity processing is necessary on the basis of whether the stack unit 12, that is, the newly determined stacking destination, stacks the recording medium 21 with the first recorded face facing up or facing down.

In this event, if the control unit judges that a recording face uniformity processing is necessary (i.e., “yes” for S6), it shifts the process to S7. In S7, the recording face uniformity processing is carried out and then the present process is finished. In contrast, if the judgment of S6 is that the recording face uniformity processing is not required (i.e., “no” for S6), no recording face uniformity processing is carried out and the present process is finished.

As described above, the image recording apparatus 1 according to the present embodiment is configured to change over the stacking destinations and also to change the orders of pages on which the images are recorded in accordance with the orientation of the recording medium when it is stacked in the new stacking destination. This configuration enables the image recording apparatus 1 to perform a continuous recording process and also enables the user to ignore the orientation of the recording medium that is output from the image recording apparatus 1, thereby reducing the user's work and improving the throughput of the recording process.

Note that the present invention may be embodied by modifying the constituent components in ways possible within the scope and spirit of the present invention in the process of embodying, in lieu of the present invention being limited to the embodiments put forth in the above description. Further, the present invention may enable various inventions by appropriately combining a plurality of constituent components disclosed in the embodiment described above. For instance, the present invention allows some constituent components to be eliminated from all constituent components put forth in the embodiment described above, and further, allows a combination of different constituent components of the individual embodiments.

For example, if a configuration is such that the stack unit is capable of stacking the recording media 21 by offsetting them, the performing of offset stacking when different jobs from the host apparatus 20 are stacked in the same stack unit makes it possible to prevent jobs with different recording face sequences from being mixed together in the stack.

The above description exemplifies the case of performing duplex printing; the present embodiment is also likewise applicable to the case of simplex printing in order to carry out uniform stacking with, for example, the printed face of the recording media 21 facing down.

Furthermore, the above described embodiment is configured to control the exit direction of the recording medium 21 in the two stack units 12 when the stacking destination of the recording medium 21 is changed to another stack unit 12 when the former destination is fully stacked. The present embodiment, however, is not limited to such a case and rather may be applied to a configuration in which a recording medium output from a stack unit 12 with the printed face facing up is changed to another control in which the recording medium 21 is output with the printed face facing down on the basis of a user instruction, or vice versa, that is, it may be applied to a configuration in which a recording medium output from a stack unit 12 with the printed face facing down is changed to another control in which the recording medium 21 is output with the printed face facing up. Such a control can be attained by changing the order between a page on which an image is recorded and a page on which no image is recorded.

What is claimed is:

1. An image recording apparatus having a plurality of stack units used for stacking recording media, the image recording apparatus comprising:
a transport path changeover unit which transports the recording media to the plurality of stack units;
an inversion unit which transports the recording medium by inverting it; and
a recording face uniformity control unit which changes over the order between the front face and back face of a printed face on the basis of print job information from a host apparatus, wherein
the recording face uniformity control unit changes over the order of the printed faces and also gives the inversion unit and the transport path changeover unit respective instructions to invert the recording medium and to change over the transport path for the recording medium, thereby stacking the recording media in the plurality of stack units with the orientation of the recorded face of the recording media uniform in each respective stack unit.

2. The image recording apparatus according to claim 1, further comprising
a control unit which comprises at least an arithmetic operation process unit and a storage unit pre-storing a control program, wherein
the control unit functions as the recording face uniformity control unit by causing the arithmetic operation process unit to execute the control program.

3. The image recording apparatus according to claim 1, further comprising
a detection unit for detecting that the plurality of stack units is full, wherein
the recording face uniformity control unit selects another stack unit capable of stacking from among the plurality of stack units if it is detected that the first stack unit from among the plurality of stack units is full on the basis of information from the detection unit.

4. The image recording apparatus according to claim 1, wherein
respective printings are performed on both faces of the recording medium on the basis of an instruction from the recording face uniformity control unit.

5. The image recording apparatus according to claim 1, wherein
a printing is performed on a single face of the recording medium on the basis of an instruction from the recording face uniformity control unit.

6. The image recording apparatus according to claim 1, wherein
the recording face uniformity control unit changes over the order between the front face and back face of a printed surface on the basis of a user instruction in place of the print job information.

7. The image recording apparatus according to claim 1, wherein
at least one of the plurality of stack units is capable of performing an offset stacking, that is, of stacking recording media by offsetting them, wherein
the recording face uniformity control unit performs the offset stacking when stacking different jobs, of jobs that the host apparatus has given instructions to perform, in the same stack unit, thereby preventing different jobs having different sequences of recorded faces from being mixed together in a stack.

8. An image recording apparatus having a plurality of stack units used for stacking recording media, the image recording apparatus comprising:
transport path changeover means for transporting the recording media to the plurality of stack means;
inversion means for transporting the recording medium by inverting it; and
recording face uniformity control means for changing over the order between the front face and back face of a printed face on the basis of print job information from a host apparatus, wherein
the recording face uniformity control means changes over the order of the printed faces and also gives the inversion means and transport path changeover means respective instructions to invert the recording medium and to change over the transport path for the recording medium, thereby stacking the recording media in the plurality of stack means with the orientation of the recorded face of the recording media uniform in each respective stack means.

9. A control method used for an image recording apparatus which records on a recording medium or media, the method comprising:
determining a stacking destination for stacking the recorded recording medium depending both on a job giving instructions that an image be formed from a host apparatus connected to the image recording apparatus and on whether or not a stacking destination stacking the recorded recording medium or media is full; and
changing over the sequences of pages on which a recording is performed on the recording medium on the basis of the information within the job and the determined stacking destination.
